(19) United States
(12) Patent Application Publication
(10) Pub. No.: US 2026/0200752 A1
(43) Pub. Date: Jul. 16, 2026

(54) METHOD FOR PRODUCING CALCIUM CARBONATE FROM A FLUE GAS

(71) Applicant: NAN YA PLASTICS CORPORATION, TAIPEI (TW)

(72) Inventors: CHING-YAO YUAN, TAIPEI (TW); CHUNG-YU CHEN, TAIPEI (TW); YI-CHENG LI, TAIPEI (TW); FANG-LING HSU, New Taipei City (TW)

(21) Appl. No.: 19/084,704

(22) Filed: Mar. 19, 2025

(30) Foreign Application Priority Data
Jan. 13, 2025 (TW) 114101234

(51) Int. Cl. C01F 11/18; B01D 53/14; B01D 53/26; B01D 53/62; B01D 53/68; B01D 53/73; B01D 53/75; B01D 53/78; B01D 53/81; B01D 53/96

(52) U.S. Cl. CPC C01F 11/18; B01D 53/1418; B01D 53/1425; B01D 53/1475; B01D 53/1493; B01D 53/265; B01D 53/62; B01D 53/685; B01D 53/73; B01D 53/75; B01D 53/78; B01D 53/81; B01D 53/96; B01D 2251/304; B01D 2251/604; B01D 2251/606; B01D 2257/2047; B01D 2257/504; B01D 2257/80; B01D 2258/0241; B01D 2258/0283

(57) ABSTRACT

A method for producing calcium carbonate from a flue gas. The method includes a carbon dioxide capturing process and a calcium carbonate forming process. The carbon dioxide capturing process is implemented by feeding an input flue gas into an alkaline aqueous solution to form a first solution. Based on a volume of the input flue gas being 100%, the input flue gas includes 10% to 80% of carbon dioxide, 6.1% to 88% of nitrogen, and 0.7% to 13.9% of oxygen. The first solution includes carbonate, and the carbonate is at least one of sodium carbonate and sodium bicarbonate. The calcium carbonate forming process is implemented by adding calcium hydroxide powders into the first solution to form a second solution, and the second solution includes calcium carbonate powders formed by the reaction between the carbonate and the calcium hydroxide powders.

### CROSS-REFERENCE TO RELATED PATENT APPLICATION

This application claims the benefit of priority to Taiwan Patent Application No. 114101234, filed on Jan. 13, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a method for producing calcium carbonate, and more particularly to a method for producing calcium carbonate from a flue gas.

### BACKGROUND OF THE DISCLOSURE

A conventional flue gas processing method is unable to effectively process flue gas, leading to difficulties in the recycling and reusing of carbon dioxide in the flue gas.

### SUMMARY OF THE DISCLOSURE

In response to the above-referenced technical inadequacy, the present disclosure provides a method for producing calcium carbonate from a flue gas, primarily to improve on the problem of a conventional flue gas processing method that is unable to effectively process the flue gas and leads to difficulties in recycling and reusing of carbon dioxide in the flue gas.

In order to solve the above-mentioned problems, one of the technical aspects adopted by the present disclosure is to provide a method for producing calcium carbonate from a flue gas. The method includes a carbon dioxide capturing process and a calcium carbonate forming process. The carbon dioxide capturing process is implemented by feeding an input flue gas into an alkaline aqueous solution to form a first solution. Based on a volume of the input flue gas being 100%, the input flue gas includes 10% to 80% of carbon dioxide, 6.1% to 88% of nitrogen, and 0.7% to 13.9% of oxygen. The alkaline aqueous solution is sodium hydroxide aqueous solution, the first solution includes carbonate, and the carbonate is at least one of sodium carbonate and sodium bicarbonate. The calcium carbonate forming process is implemented by adding calcium hydroxide powders into the first solution to form a second solution, and the second solution includes calcium carbonate powders formed by the reaction of the carbonate and the calcium hydroxide powders.

In one of the possible or preferred embodiments, in the carbon dioxide capturing process, based on the volume of the input flue gas being 100%, the input flue gas includes 60% to 80% of carbon dioxide, 6.1% to 26.1% of nitrogen, and 4.7% to 13.9% of oxygen.

In one of the possible or preferred embodiments, after the carbon dioxide capturing process and before the calcium carbonate forming process, the method further includes a pH value measuring process implemented by measuring a pH value of the first solution, and starts implementing the calcium carbonate process when the pH value of the first solution is between 11 and 12.

In one of the possible or preferred embodiments, in the calcium carbonate forming process, the second solution further includes sodium hydroxide formed by the reaction of the carbonate and the calcium hydroxide powders, and the sodium hydroxide is configured to be recycled and to serve as the alkaline aqueous solution in the carbon dioxide capturing process.

In one of the possible or preferred embodiments, in the calcium carbonate forming process, a pH value of the second solution is controlled between 12 and 14.

In one of the possible or preferred embodiments, in the calcium carbonate forming process, an exhaust gas is formed. Based on a volume of the exhaust gas being 100%, the exhaust gas includes 5% to 8% of carbon dioxide, 88% to 93% of nitrogen, and 2% to 4% of oxygen.

In one of the possible or preferred embodiments, the method is configured to provide a carbon dioxide recycling rate of greater than 80%, and the carbon dioxide recycling rate is defined by a difference between a content of the carbon dioxide in the input flue gas and a content of the carbon dioxide in the exhaust gas divided by the content of the carbon dioxide in the input flue gas.

In one of the possible or preferred embodiments, before the carbon dioxide capturing process, the method further includes a preparing process, an acid removing process, and a cooling and water removing process. The preparing process is implemented by collecting a flue gas generated by oxygen-enriched combustion of a glass raw material with methane from a glass furnace. The flue gas includes the carbon dioxide, nitrogen, water vapor, oxygen, fluoric acid compounds, and boric acid compounds. The acid removing process is implemented by performing a first acid removing operation on the flue gas. The first acid removing operation is implemented by using a sodium hydroxide aqueous solution to remove the fluoric acid compounds and the boric acid compounds in the flue gas. The cooling and water removing process is implemented by reducing a temperature of the flue gas to between 20° C. and 40° C. and reducing a content of the water vapor in the flue gas. After the cooling and water removing process, the flue gas is configured to serve as the input flue gas in the carbon dioxide capturing process.

In one of the possible or preferred embodiments, in the acid removing process, a second acid removing operation is further performed on the flue gas, and the second acid removing operation is implemented by using sodium bicarbonate powders to remove the fluoric acid compounds and the boric acid compounds in the flue gas.

In one of the possible or preferred embodiments, in the preparing process, based on a volume of the flue gas being 100%, a content of the carbon dioxide is between 30% and 34%, a content of the nitrogen is between 1% and 5%, a content of the water vapor is between 58% and 62%, and a content of the oxygen is between 2% and 6%.

Therefore, in the method for producing calcium carbonate from the flue gas provided by the present disclosure, by virtue of “the carbon dioxide capturing process being implemented by feeding the input flue gas into the alkaline aqueous solution to form the first solution” and “the calcium carbonate forming process being implemented by adding calcium hydroxide powders into the first solution to form the second solution, and the second solution including calcium carbonate powders formed by the reaction of the carbonate and the calcium hydroxide powders,” the problem of the conventional flue gas processing method being unable to effectively process the flue gas leading to difficulties in recycling and reusing the carbon dioxide in the flue gas can be effectively improved.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method for producing calcium carbonate from a flue gas according to a first embodiment of the present disclosure;

FIG. 2 is a flowchart of a method for producing calcium carbonate from a flue gas according to a second embodiment of the present disclosure; and

FIG. 3 is a flowchart of a method for producing calcium carbonate from a flue gas according to a third embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

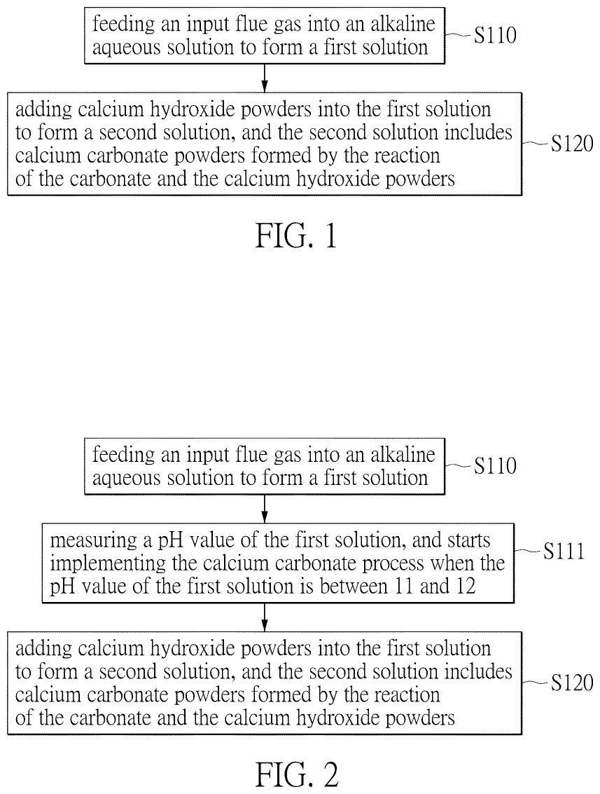

Referring to FIG. 1, FIG. 1 is a flowchart of a method for producing calcium carbonate from a flue gas according to a first embodiment of the present disclosure. The present embodiment provides a method for producing calcium carbonate from a flue gas. The method for producing calcium carbonate from the flue gas includes a carbon dioxide capturing process S110 and a calcium carbonate forming process S120. Naturally, the method for producing calcium carbonate from the flue gas can include other processes according to practical requirements, but the present disclosure is not limited thereto.

The carbon dioxide capturing process S110 is implemented by feeding an input flue gas into an alkaline aqueous solution to form a first solution. The alkaline aqueous solution is sodium hydroxide aqueous solution, the first solution includes carbonate, and the carbonate is at least one of sodium carbonate and sodium bicarbonate. The carbonate is formed by the reaction of the alkaline aqueous solution and the carbon dioxide in the input flue gas. A weight percentage concentration of the alkaline aqueous solution can be, for example, between 3% and 10%, but the present disclosure is not limited thereto.

In the carbon dioxide capturing process S110, based on a volume of the input flue gas being 100%, the input flue gas includes 10% to 80% of carbon dioxide, 6.1% to 88% of nitrogen, and 0.7% to 13.9% of oxygen. It is worth mentioning that, a flue gas generated by burning a glass raw material through a glass furnace can be fed into a first reaction equipment (not shown) where the carbon dioxide capturing process S110 is implemented to form the input flue gas, but the present disclosure is not limited thereto. In addition, the first reaction equipment can be, for example, a hypergravity equipment, but the present disclosure is not limited thereto.

More specifically, a manner of burning the glass raw material through the glass furnace can be distinguished into an air combustion manner and an oxygen-enriched combustion with methane manner. When burning the glass raw material through the glass furnace in the air combustion manner, based on the volume of the input flue gas being 100%, the input flue gas includes 10% to 18% of carbon dioxide, 80% to 88% of nitrogen, and 0.7% to 2% of oxygen.

Preferably, in the carbon dioxide capturing process S110, the input flue gas can be generated by burning the glass raw material through the glass furnace in the oxygen-enriched combustion with methane manner, and based on the volume of the input flue gas being 100%, the input flue gas includes 60% to 80% of carbon dioxide, 6.1 % to 26.1% of nitrogen, and 4.7% to 13.9% of oxygen, but the present disclosure is not limited thereto.

It is worth mentioning that, compared to the flue gas generated by burning the glass raw material in the air combustion manner, the flue gas generated by burning the glass raw material in the oxygen-enriched combustion with methane manner includes a high volume ratio of carbon dioxide, thereby being more suitable to be used as the input flue gas in the carbon dioxide capturing process S110.

The calcium carbonate forming process S120 is implemented by adding calcium hydroxide powders into the first solution to form a second solution, and the second solution includes calcium carbonate powders formed by the reaction of the carbonate and the calcium hydroxide powders. After the calcium carbonate forming process S120, the calcium carbonate powders can be filtered and separated.

In addition, in the calcium carbonate forming process S120 of the present embodiment, the second solution can include sodium hydroxide formed by the reaction of the carbonate and the calcium hydroxide powders, and the sodium hydroxide is configured to be recycled and to serve as the alkaline aqueous solution in the carbon dioxide capturing process S110.

In addition, in the calcium carbonate forming process S120, an exhaust gas is further formed. Specifically, the calcium carbonate forming process S120 can be implemented in a second reaction equipment (not shown), and the exhaust gas can be regarded as a gas exhausted from the second reaction equipment after implementing the calcium carbonate forming process S120. The second reaction equipment can be, for example, another hypergravity equipment, but the present disclosure is not limited thereto. Based on a volume of the exhaust gas being 100%, the exhaust gas includes 5% to 8% of carbon dioxide, 88% to 93% of nitrogen, and 2% to 4% of oxygen.

In the calcium carbonate forming process S120 of the present embodiment, a pH value of the second solution is controlled between 12 and 14, but the present disclosure is not limited thereto.

The method for producing calcium carbonate from the flue gas is configured to provide a carbon dioxide recycling rate of greater than 80%, and the carbon dioxide recycling rate is defined by a difference between a content of the carbon dioxide in the input flue gas and a content of the carbon dioxide in the exhaust gas divided by the content of the carbon dioxide in the input flue gas. Preferably, the method for producing calcium carbonate from the flue gas is configured to provide a carbon dioxide recycling rate of between 86.66% and 93.75%.

### Second Embodiment

Referring to FIG. 2, FIG. 2 is a flowchart of a method for producing calcium carbonate from a flue gas according to a second embodiment of the present disclosure. The second embodiment of the present embodiment is similar to the above-mentioned first embodiment, the similar parts of the two embodiments will not be reiterated herein, and the differences between the two embodiments are described as follows.

In the present embodiment, after the carbon dioxide capturing process S110 and before the calcium carbonate forming process S120, the method further includes a pH value measuring process S111 implemented by measuring a pH value of the first solution, and starts implementing the calcium carbonate process S120 when the pH value of the first solution is between 11 and 12.

Through the pH value measuring process S111, it can be ensured that the carbon dioxide in the input flue gas can more completely react with the alkaline aqueous solution. After the pH value measuring process S111, the first solution can be transferred from the first reaction equipment to the second reaction equipment for implementing the calcium carbonate forming process S120.

### Third Embodiment

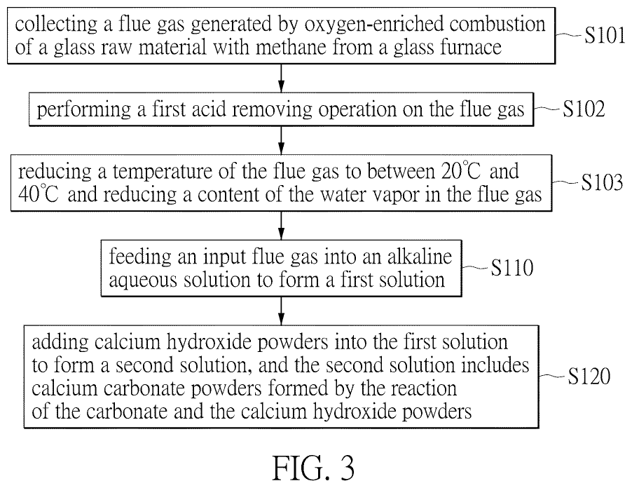

Referring to FIG. 3, FIG. 3 is a flowchart of a method for producing calcium carbonate from a flue gas according to a third embodiment of the present disclosure. A third embodiment of the present disclosure is similar to the above-mentioned first embodiment, the same parts of the two embodiments will not be reiterated herein, and the differences between the two embodiments are described as follows. Before the carbon dioxide capturing process S110, the method for producing calcium carbonate from the flue gas further includes a preparing process S101, an acid removing process S102, and a cooling and water removing process S103.

The preparing process S101 is implemented by collecting a flue gas generated by oxygen-enriched combustion of a glass raw material with methane from a glass furnace. The flue gas includes the carbon dioxide, nitrogen, water vapor, oxygen, fluoric acid compounds, and boric acid compounds. Preferably, based on a volume of the flue gas being 100%, a content of the carbon dioxide is between 30% and 34%, a content of the nitrogen is between 1% and 5%, a content of the water vapor is between 58% and 62%, and a content of the oxygen is between 2% and 6%.

The fluoric acid compounds can be an acid component such as hydrofluoric acid, and the boric acid compounds can be acid components such as boric acid, oxoborinic acid, boron trioxide, or boron trifluoride. However, the present disclosure does not limit the specific materials of the fluoric acid compounds and boric acid compounds. It is worth mentioning that, the fluoric acid compounds and the boric acid compounds are generated by burning the glass raw material.

In the preparing process S110 of the present embodiment, a content of the fluoric acid compounds is greater than 0 mg/m³ and less than 500 mg/m³, and a content of the boric acid compounds is greater than 0 mg/m³ and less than 15 mg/m³, but the present disclosure is not limited thereto.

The acid removing process S102 is implemented by performing a first acid removing operation on the flue gas. The first acid removing operation is implemented by using a sodium hydroxide aqueous solution to remove the fluoric acid compounds and the boric acid compounds in the flue gas. In the present embodiment, a weight percent concentration of the sodium hydroxide aqueous solution is within a range from 2% to 4%, but the present disclosure is not limited thereto. In addition, the sodium hydroxide aqueous solution in the acid removing process S102 can be the same as or different from the sodium hydroxide aqueous solution in the carbon dioxide capturing process S110, but the present disclosure is not limited thereto.

Preferably, in the acid removing process S102, a second acid removing operation is further performed on the flue gas, and the second acid removing operation is implemented by using sodium bicarbonate powders to remove the fluoric acid compounds and the boric acid compounds in the flue gas. In addition, the first acid removing operation and the second acid removing operation can be respectively performed in a semi-dry acid removal tower (not shown) and dry acid removal unit (not shown), but the present disclosure is not limited thereto.

The cooling and water removing process S103 is implemented by reducing a temperature of the flue gas to between 20° C. and 40° C. and reducing a content of the water vapor in the flue gas. The cooling and water removing process S102 can be implemented in a cooling and water removing unit (not shown), but the present disclosure is not limited thereto. After the cooling and water removing process S103, the flue gas is configured to serve as the input flue gas in the carbon dioxide capturing process S110.

More specifically, after reducing the temperature of the flue gas, the water vapor in the flue gas condenses into water and the water can be removed, and accordingly, the content of the water vapor in the flue gas can be reduced. After the cooling and water removing process S103, based on the volume of the input flue gas being 100%, the input flue gas includes 60% to 80% of carbon dioxide, 6.1% to 26.1% of nitrogen, and 4.7% to 13.9% of oxygen.

### Beneficial Effects of the Embodiments

In conclusion, in the method for producing calcium carbonate from the flue gas provided by the present disclosure, by virtue of “the carbon dioxide capturing process being implemented by feeding the input flue gas into the alkaline aqueous solution to form the first solution” and “the calcium carbonate forming process being implemented by adding calcium hydroxide powders into the first solution to form the second solution, and the second solution including calcium carbonate powders formed by the reaction of the carbonate and the calcium hydroxide powders,” the problem of the conventional flue gas processing method being unable to effectively process the flue gas and leading to difficulties in recycling and reusing the carbon dioxide in the flue gas can be effectively improved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for producing calcium carbonate from a flue gas, comprising:
a carbon dioxide capturing process implemented by feeding an input flue gas into an alkaline aqueous solution to form a first solution, wherein, based on a volume of the input flue gas being 100%, the input flue gas includes 10% to 80% of carbon dioxide, 6.1% to 88% of nitrogen, and 0.7% to 13.9% of oxygen, and wherein the alkaline aqueous solution is sodium hydroxide aqueous solution, the first solution includes carbonate, and the carbonate is at least one of sodium carbonate and sodium bicarbonate; and
a calcium carbonate forming process implemented by adding calcium hydroxide powders into the first solution to form a second solution, and the second solution includes calcium carbonate powders formed by the reaction of the carbonate and the calcium hydroxide powders.

2. The method according to claim 1, wherein, in the carbon dioxide capturing process, based on the volume of the input flue gas being 100%, the input flue gas includes 60% to 80% of carbon dioxide, 6.1% to 26.1% of nitrogen, and 4.7% to 13.9% of oxygen.

3. The method according to claim 1, wherein, after the carbon dioxide capturing process and before the calcium carbonate forming process, the method further includes a pH value measuring process implemented by measuring a pH value of the first solution, and starts implementing the calcium carbonate process when the pH value of the first solution is between 11 and 12.

4. The method according to claim 1, wherein, in the calcium carbonate forming process, the second solution further includes sodium hydroxide formed by the reaction of the carbonate and the calcium hydroxide powders, and the sodium hydroxide is configured to be recycled and to serve as the alkaline aqueous solution in the carbon dioxide capturing process.

5. The method according to claim 1, wherein, in the calcium carbonate forming process, a pH value of the second solution is controlled between 12 and 14.

6. The method according to claim 1, wherein, in the calcium carbonate forming process, an exhaust gas is formed, and wherein, based on a volume of the exhaust gas being 100%, the exhaust gas includes 5% to 8% of carbon dioxide, 88% to 93% of nitrogen, and 2% to 4% of oxygen.

7. The method according to claim 1, wherein the method is configured to provide a carbon dioxide recycling rate of greater than 80%, and the carbon dioxide recycling rate is defined by a difference between a content of the carbon dioxide in the input flue gas and a content of the carbon dioxide in the exhaust gas divided by the content of the carbon dioxide in the input flue gas.

8. The method according to claim 1, wherein, before the carbon dioxide capturing process, the method further includes:
a preparing process implemented by collecting a flue gas generated by oxygen-enriched combustion of a glass raw material with methane from a glass furnace, wherein the flue gas includes the carbon dioxide, nitrogen, water vapor, oxygen, fluoric acid compounds, and boric acid compounds;
an acid removing process implemented by performing a first acid removing operation on the flue gas, wherein the first acid removing operation is implemented by using a sodium hydroxide aqueous solution to remove the fluoric acid compounds and the boric acid compounds in the flue gas; and
a cooling and water removing process implemented by reducing a temperature of the flue gas to between 20° C. and 40° C. and reducing a content of the water vapor in the flue gas;
wherein, after the cooling and water removing process, the flue gas is configured to serve as the input flue gas in the carbon dioxide capturing process.

9. The method according to claim 8, wherein, in the acid removing process, a second acid removing operation is further performed on the flue gas, and the second acid removing operation is implemented by using sodium bicarbonate powders to remove the fluoric acid compounds and the boric acid compounds in the flue gas.

10. The method according to claim 8, wherein, in the preparing process, based on a volume of the flue gas being 100%, a content of the carbon dioxide is between 30% and 34%, a content of the nitrogen is between 1% and 5%, a content of the water vapor is between 58% and 62%, and a content of the oxygen is between 2% and 6%.
